(19) United States
(12) Patent Application Publication
(10) Pub. No.: US 2013/0159056 A1
(43) Pub. Date: Jun. 20, 2013

(54) SYSTEMS AND METHODS FOR OBTAINING MARKETING AND SALES INFORMATION FROM THE EVALUATION OF PRODUCTS FOR PURCHASE

(71) Applicants: Christopher John DOIG, Escondido, CA (US); Sean Harold NOLAN, Schaumburg, IL (US)

(72) Inventors: Christopher John DOIG, Escondido, CA (US); Sean Harold NOLAN, Schaumburg, IL (US)

(73) Assignee: WAYFERRY, INC., Escondido, CA (US)

(21) Appl. No.: 13/407,693

(22) Filed: Feb. 28, 2012

Related U.S. Application Data
(60) Provisional application No. 61/447,547, filed on Feb. 28, 2011.

(51) Int. Cl. G06Q 30/02

(52) U.S. Cl. CPC G06Q 30/0203
USPC 705/7.32

(57) ABSTRACT

Disclosed herein are methods of evaluating products and of selling information collected by the evaluation system; namely of advertising to evaluators performing product evaluations, of selling access to evaluators during the product evaluation process, of selling aggregate, trend and statistical information derived from evaluations on the system; of selling completed product evaluations and of paying evaluators a portion of the earnings from these sales. Also disclosed herein is a system for evaluating products and of selling information collected by the evaluation system; namely of advertising to evaluators performing product evaluations, of selling access to evaluators during the product evaluation process, of selling aggregate, trend and statistical information derived from evaluations on the system; of selling completed product evaluations and of paying evaluators a portion of the earnings from these sales.

### RELATED APPLICATIONS

This application claims priority to the U.S. Provisional Application Ser. No. 61/447,547, filed on Feb. 28, 2011 by Doig et al., and entitled “SYSTEMS AND METHODS FOR EVALUATION OF PRODUCTS FOR PURCHASE,” the entire disclosure of which, including the drawings, is incorporated by reference herein.

### FIELD OF THE INVENTION

This invention relates to software and systems designed for a computerized system for evaluating relatively complex products being considered for purchase, and of then using information related to and derived from the product evaluations. In particular, the invention relates to software and systems for selling the information produced during and by the process of evaluating products, for creating earnings from the sales of this information, and for remitting a portion of these sales earnings back to the product evaluators.

### BACKGROUND OF THE DISCLOSURE

Current purchase evaluation procedures in business and industry are usually based on personal experience or evaluation matrixes (usually spreadsheets). Of course it is possible to evaluate and compare products using a database, but it is usually not considered worth the development effort. Sometimes current practice results in outcomes ranging from sub-optimum purchases to outright purchasing failures where a product is bought and later discarded. Not only can this waste substantial sums of money, but business opportunities can be lost when staff waste time resolving problems that could have been avoided by a better purchase.

Purchasing decision makers not that familiar with a product domain usually construct some sort of evaluation matrix typically using a spreadsheet where products are rated. However such spreadsheets take a lot of work and skill to construct, and have significant limitations:
1. Spreadsheets can't easily handle relational data constructs.
2. Spreadsheets error checking is relatively limited and often not used.
3. Collaboration with spreadsheets can be difficult and slow.
4. Spreadsheets lack adequate audit trails.
5. Spreadsheets provide only very limited means of documenting the context behind ratings (i.e. a text comment only, no provision for attaching files or screen shots).
6. Spreadsheets provide no practical means of using or selling the information generated during and by the product evaluation process.

Once complete, evaluation projects are usually filed away, forgotten and sometimes lost. Sometimes this causes problems for companies when they want to make a change and can't recall the reason why a particular product was bought. In business or industry, post-purchase evaluations are conducted on very few purchases, if at all.

People evaluating products for purchase are, by definition, interested in making a purchase. Sales leads generated from active product evaluations are very valuable to vendors, and are of far higher quality than most other current sources of sales leads.

If vendors want to know the rate at which their products are being evaluated in real time current options are limited and fragmented. Online services can measure this by looking at the rate test accounts are requested. Other products can look at the rate sales people are contacted. Surveys can measure market interest. Key words and phrases can be tracked in search engines. But there is no easy way for a vendor to measure the results of a product marketing campaign real time.

Currently there is little thought of sharing, reusing or selling information generated during and by evaluating products as part of purchase decisions. However these product evaluations are of great value because they:
1. Allow vendor marketing departments to see their product through the eyes of the purchasers evaluating competing products.
2. Allow the vendor marketing departments to see how their products compare to competing products through the eyes of purchasers evaluating those products.
3. Allow marketing departments so see what product evaluators think about their products to a greater depth of detail that almost any other method.
4. Evaluations are very useful to other companies facing similar purchase decisions.

### SUMMARY OF THE INVENTION

In one aspect, disclosed herein are methods for collecting and selling information generated during and by the process of evaluating products for purchase, namely:
1. Of selling product vendors access to evaluators during the product evaluation process (i.e. selling sales leads).
2. Of selling aggregate, trend and statistical information derived from evaluations on the system.
3. Of selling completed product evaluations
4. The option of paying evaluators a portion of the earnings from these sales.

In some embodiments, each evaluation requirement is related to a feature or function of the product. In other embodiments, the score for each requirement is weighted based on the importance of the requirement in the overall evaluation. In further embodiments, the set of requirements are stored on the evaluation system. In additional embodiments, the set of requirements is provided by the evaluator, whereas in other embodiments, the set of requirements is provided by someone other than the evaluator. In some embodiments, evaluation project records are created by the evaluator. In further embodiments, a product vendor has access to the evaluation system and the vendor creates product records which may be used by evaluators.

In some embodiments, the evaluating is performed by a plurality of evaluators. In other embodiments, the product cumulative score is a function of the cumulative score of each one of the plurality of evaluators. In further embodiments, the cumulative score for at least one of the plurality of evaluators is weighted differently than the cumulative score of at least one other of the plurality of evaluators.

In some embodiments, the product cumulative score is the sum of the scores for the requirements. In other embodiments, the product cumulative score is the weighted sum of the scores for the requirements. In further embodiments, the product cumulative score is the sum of cumulative score of the plurality of evaluators. In additional embodiments, the product cumulative score is the weighted sum of cumulative score of the plurality of evaluators.

In some embodiments, the method further comprises evaluating a plurality of products; using a processor, determining a cumulative score for each product; and using a processor, determining which product has the highest cumulative score. In other embodiments, the method further comprises providing access to the evaluation project records to a non-evaluating party. In some of these embodiments, the non-evaluating party is a vendor of a product or an advertiser for the product. In some embodiments, the access is a paid access. In further embodiments, the method further comprises providing access to the server to a payment system. In some embodiments, the access is only allowed once the evaluation process is complete. In other embodiments, the access is allowed throughout the evaluation process.

In another aspect, disclosed herein is a system for evaluating products and of selling information collected by the evaluation system; namely of advertising to evaluators performing product evaluations, of selling access to evaluators during the product evaluation process, of selling aggregate, trend and statistical information derived from evaluations on the system; of selling completed product evaluations and of paying evaluators a portion of the earnings from these sales.

In some embodiments, the first processor is in communication with a second processor selected from the group consisting of a processor of an evaluator of the product, a processor of a vendor of the product, a processor of an advertiser; and a processor of a payment system. In certain embodiments, the communication is through the internet. In some of these embodiments, the system further comprises a firewall between the first processor and the second processor.

### BRIEF DESCRIPTION OF THE DRAWINGS

FIG. 1 is a block diagram and provides an illustration overview of the major hardware components involved in one embodiment of the evaluation system disclosed herein.

FIG. 2, which is a system context diagram showing how the roles of various users relate to the disclosed evaluation system.

FIG. 3 is a Conceptual Entity Relationship diagram that shows how the major parts of an evaluation relate together.

FIG. 4 is a high level evaluation flow chart. This chart shows the overall process of one evaluation from start to end.

FIG. 5 is a high level vendor action flow chart, which shows the high level processes used when vendors interact with the disclosed system.

### DETAILED DESCRIPTION OF THE EMBODIMENTS

The following is a detailed description of certain specific embodiments of the present invention. In this description reference is made to the drawings where like parts are designated with like numerals throughout. For convenience the discussion of the invention is organized into sections that correspond approximately to the steps in evaluating a product.

### DEFINITIONS

In the present disclosure, the terms below are defined. Numbers in these definitions refer to numbers in the figures.

Click through rate: A way to measure success in online advertising. The click though rate is calculated using the formula:

(# of users who clicked on an ad)/(# of times an ad was delivered)

For example, if an advertisement was delivered 100 times and 3 people clicked on it, then the resulting click though rate would be 3 percent.

Customer: A person or organization who purchases information from the system 202, e.g. an evaluation project 310. These can be evaluators 106, vendors 108, advertisers 114, market researchers etc. See also Product buyer below.

Discussion thread 414: A series of short comments, usually from multiple people that form a “digital conversation” on a particular topic. Discussion threads 414 on evaluation projects 310 are always attached to something, e.g. a requirement 320, a product 370 etc.

Evaluating (verb): The process of examining product 370 claims against user purchase requirements 320 for the purposes of purchasing 420 the product 370 that best matches those requirements 320.

Evaluation (noun): Depending on the context may refer to an evaluation project 310, or the evaluation of just one product 370 on an evaluation project 310.

Evaluation access list 313: Explicitly defines who may access an evaluation 310, and what level of access they have to that evaluation 310. Note that users not specifically named in the Evaluation Access List 313 may purchase access the evaluation 310 as specified by the Evaluation Disclosure Level 312.

Evaluation disclosure level 312: Controls how much information is available to purchasers of an evaluation 310. See Table 5—Evaluation Disclosure Levels and Table 6—Evaluation Access Levels.

Evaluation owner 106: By default, the person who creates an evaluation project 310 is automatically the owner of that project. In some embodiments, every evaluation project 310 has an evaluation owner. The evaluation owner can be changed. In one embodiment, the evaluation owner is the person who earns remuneration when the evaluation is sold. The evaluation owner 106 may invite other people to participate in the evaluation project, and controls the access they have to the evaluation project 310.

Evaluation project 310: A data object in the disclosed system 202 that can contain purchase requirements 320, products 370, and a measure of how well those products meet those requirements. For simplicity may be shortened to “Evaluation”. Compare to product evaluation below.

Evaluator 106: A user who is using the disclosed system 202 to evaluate competing products 370 which may result in a purchase 420 of the product 370 best suited to their requirements 320. The evaluator 106 is a potential buyer of products from the vendor 108.

Hypothetically perfect product: An internal (hidden) product on an evaluation that fully meets all requirements and is used as a point of reference. In some embodiments all products are compared to the hypothetically perfect product and product scores 372 are expressed as a percentage of the hypothetically perfect product's score.

Impressions: Impressions are common way some Web advertising is sold, and the price is usually quoted as the cost per thousand impressions. It is the count of how many times an advertisement is displayed on a user's screen.

Product 370: Anything offered to a market that may satisfy a want or a need. In particular, a product 370 is any package of goods or services or combination thereof that could be evaluated for purchase from a vendor 108.

Product buyer: A person or organization that purchases products from a vendor. Often the same as the product evaluator 106.

Product catalog 504: A list of products 370 maintained in the evaluation system 202 disclosed herein primarily by vendors 108 primarily for the purpose of allowing evaluators 106 add those products 408 to their evaluations.

Product evaluation: The act of measuring or estimating how well a product 370 meets the purchase requirements 320 in an evaluation project 310. Evaluation projects 310 contain at least one product evaluation.

Product score 372: In one embodiment, Product score 372 is a function of all individual requirement group scores 348 for a product 370. This number may be computed or expressed in several ways, but is most useful as a percentage of what a hypothetically perfect product would score, e.g. if the hypothetically perfect product which fully meets every requirement scored 250 points, and the evaluated product scored 180 points, this would be expressed as 72%, i.e. (180/250)*100. Other embodiments may compute and express the product scores differently.

Requirements 320: The purpose of product evaluation 310 is to determine how well the features of a product 370 meet the requirements 320 of an evaluator 106.

Requirement group 340: A collection of related requirements, e.g. the “Security” or “Compliance” groups of requirements.

Requirement group score 348: In this embodiment the average of all the individual requirement scores 356 in a requirement group. Other embodiments may compute the requirement group score differently.

Requirement importance 326: A measure of how important a requirement 320 is to the evaluator 106. In this embodiment every requirement importance has a numerical value 332 and a name 334, e.g. “4—Very Important” or “2—Useful”. It also has a description 336—see Table 1—Requirements Importance 330.

Requirement rating 352 (noun): The result of the evaluator 106 recording how well one product 370 meets one particular requirement 320. In this embodiment every requirement rating 352 has a numerical value 362 and a name 364, e.g. “4—Fully Meets” or “1—Slightly Meets”. It also has a description 366, see Table 2—Requirement Ratings 360.

Requirement rating (verb): The process of evaluating a product 370 against one particular requirement 320, and recording how well the product meets that requirement. The requirement rating is used to calculate the requirement score 356.

Requirement score 356: A computed numerical measure of how well the product 370 meets a requirement 320, how important that requirement is 326, and in some embodiments, the requirement group weights. In this embodiment the product score 372 is a function of all individual requirement scores 356 for one product 370, for example a linear sum or a weighted sum of all individual requirement scores 356 for one product 370.

Role: A means of describing systems by expressing things in ways analogous to our conceptual understanding of the world. For example the same user (person) can be in the evaluator 106 role for one product when he is evaluating products for purchase by his organization, but also in the vendor 108 role for another product when he is selling different products for his organization.

Sales lead: The contact details of an evaluator 106 made available for purchase to vendors 108 of products on that evaluation and similar products. These sales leads are very valuable to vendors because the evaluator usually has decided to buy, but is still deciding which product to buy. Often this is the vendor's last opportunity to influence the evaluator to buy their product.

Show stopper: The highest level of requirement importance 326 that if not adequately satisfied, automatically excludes the evaluated product 370 from purchase.

Statistical reports: Reports from queries run on the system 202 showing statistical information (as opposed to detailed information). Example: a report on the number of laptops evaluated per geographic area per unit time. The report may also include things like the rates at which new evaluations 310 are being added to the system 202 over time.

System 202: The software that allows user 106 to evaluate products 370 for the purposes of making purchasing decisions 420. This software also allows the sale of information created during and by the evaluation process. This software requires one or more computer servers 201 on which it is run, which is also considered part of the system 202. In some embodiments this software stores the information collected and created in a database 104 which is also considered part of the system 202.

System user ID 382: An identification internal to the disclosed system 202 that uniquely identifies a person as a user in that system.

User: A person with an account on the disclosed system 202, that uses the system 202 for one or more specific purposes. Examples of users are people who are evaluating products 106 and vendors 108 who purchase sales leads or completed evaluations.

Vendor 108: The entity selling the products 370 being evaluated for possible purchase 420.

Vendor connect: A name for the family of technologies 376, 377 & 316 used to connect vendors 108 to potential product buyers.

### Introduction

In one aspect, disclosed herein, are computerized purchase evaluation services for those individuals engaged in complex purchasing decisions. In some embodiments, the purchase evaluation services are Web based, whereas in other embodiments, the purchase evaluation services are based on an internal server or desk top computer. In some embodiments, the purchasing decisions 420 are at a corporate level, e.g. purchasing a new accounting system for a large company, while in other embodiments, the purchasing decisions are made by an individual, e.g. purchasing a new car. The evaluation services disclosed herein may integrate all aspects of a purchase decision into an evaluation project.

In one embodiment, the evaluator 106 creates a user account on the system 202, and then creates an evaluation project 310 for a particular purchase. The evaluator enters the purchase requirements 406. Then potential products are added 408 to the evaluation project 310, and the evaluator evaluates each product 370 against those requirements 320.

The process of evaluating consists of rating how well a product meets each requirement. Each product 370 is rated until most or all products have been rated against the requirements 320. The process of rating generates a product score 372 for each product 370. The evaluator then selects a product 370 for purchase based on the product score 372, for example purchasing the product 370 with the highest product score 372.

In some embodiments the evaluation project 310 is completed when it is moved by the evaluator 106 into the “Completed” workflow state 318.

In some embodiments, the evaluator 106 offers the evaluation project 310 for sale 424 because evaluations are valuable to other evaluators and vendors of the evaluated products. In other embodiments, the evaluator 106 can increase their earnings from an evaluation project 310 by adding a post purchase evaluation 422. In further embodiments, the evaluator 106 does not offer the evaluation project 310 for sale and instead keeps the evaluation project 310 solely for internal use.

Vendors 108 can purchase copies of completed product evaluations 310 for detailed market analysis. With appropriate permissions from evaluators 106, vendors 108 can purchase access to the evaluators 106 themselves during the evaluation but before the purchase decision is made (i.e. the vendor is purchasing a sales lead). Vendors 106 can also track the rate at which their products are being evaluated in the system 202, and use this to dynamically adjust product features or marketing campaigns in real time

### Hardware and Software Platform Overview

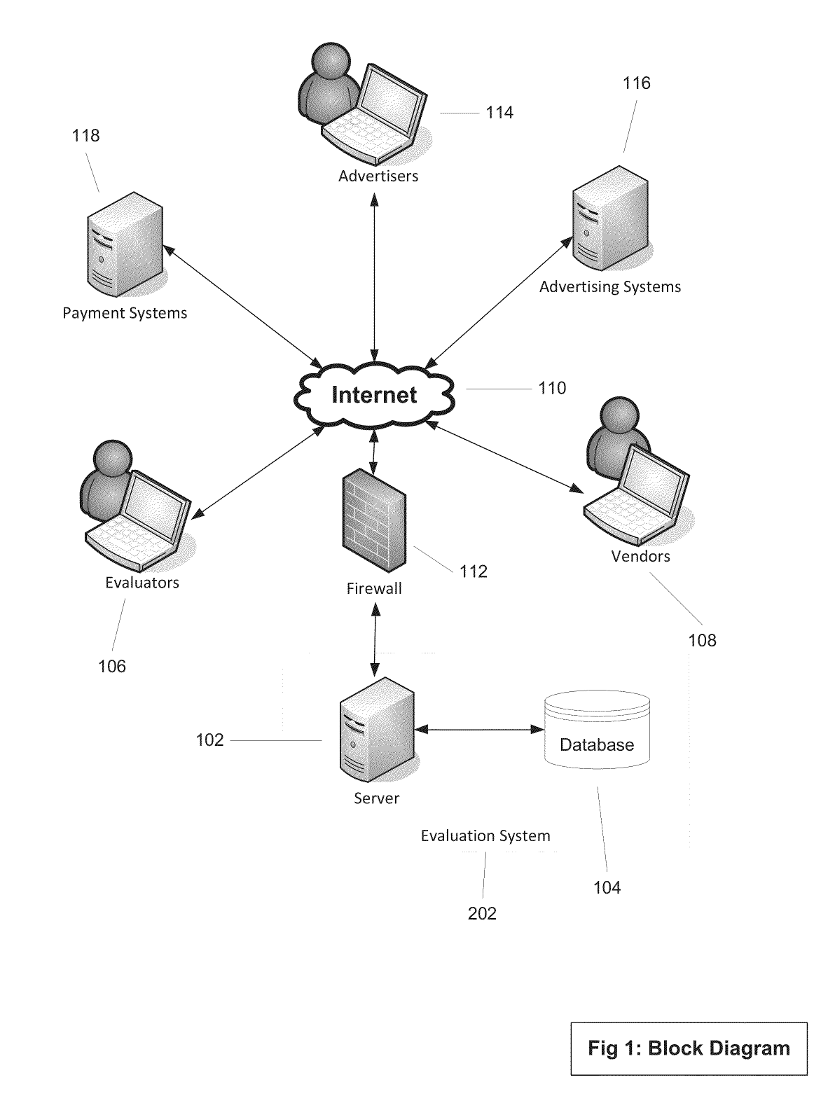

FIG. 1 provides an illustration overview of the major hardware components involved in one embodiment of the evaluation system disclosed herein, and how they relate to external systems and users. In this embodiment the disclosed system 202 includes a web server component 102, which can be based on any commercially available server hardware running an open source or commercially available operating system like Linux or Microsoft Windows Server. The system 202 could be written in any open source or commercial language or framework like Java, PHP, ASP.NET, etc.

In one embodiment the server is a web server. A web server is a computer processor that can be accessed from the outside of the station to which it is physically attached through the internet. In other embodiments, the server is a local server. A local server can only be accessed through an intranet, or a local area network, to which only a select group of computers, normally all on the same network. In other embodiments, the processor can only be accessed through the computer to which it is attached, i.e., it is a stand-alone computer station.

In some embodiments, the server 102 hosts all the information related to the evaluation process. One or more databases 104 contain the information related to the evaluation projects 310. For example, all the requirements for a product, the description of the products being evaluated, the ratings of the various evaluators, etc., are saved in the databases 104 housed on the server 102.

The database component 104 can be any commercially available or open source database such as Oracle, SQL Server or MySQL. Of course many other standard and non-standard computer systems may support various embodiments of the evaluation system 202, which can run on one or more servers 102. Any database developed in the future that can integrate with the other components of the system disclosed herein can also be used.

In some embodiments, the web server 102 is connected to the Internet 110. In some embodiments, the connection to the Internet 110 is through a firewall 112 to protect the integrity of the web server 102 and the database 104. FIG. 1 illustrates how external users like evaluators 106 or vendors 108 can access the system 202 through the Internet 110. Likewise external systems like payment systems 118 and advertising systems 116 can also access the system 202.

### System Roles

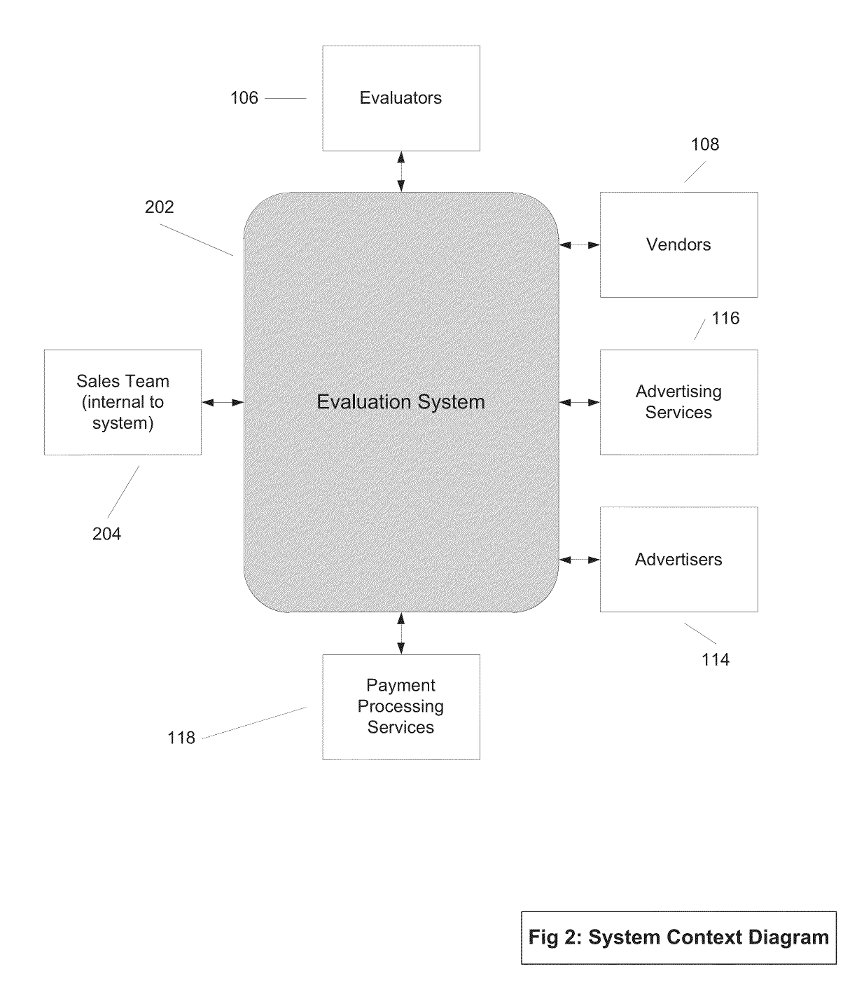

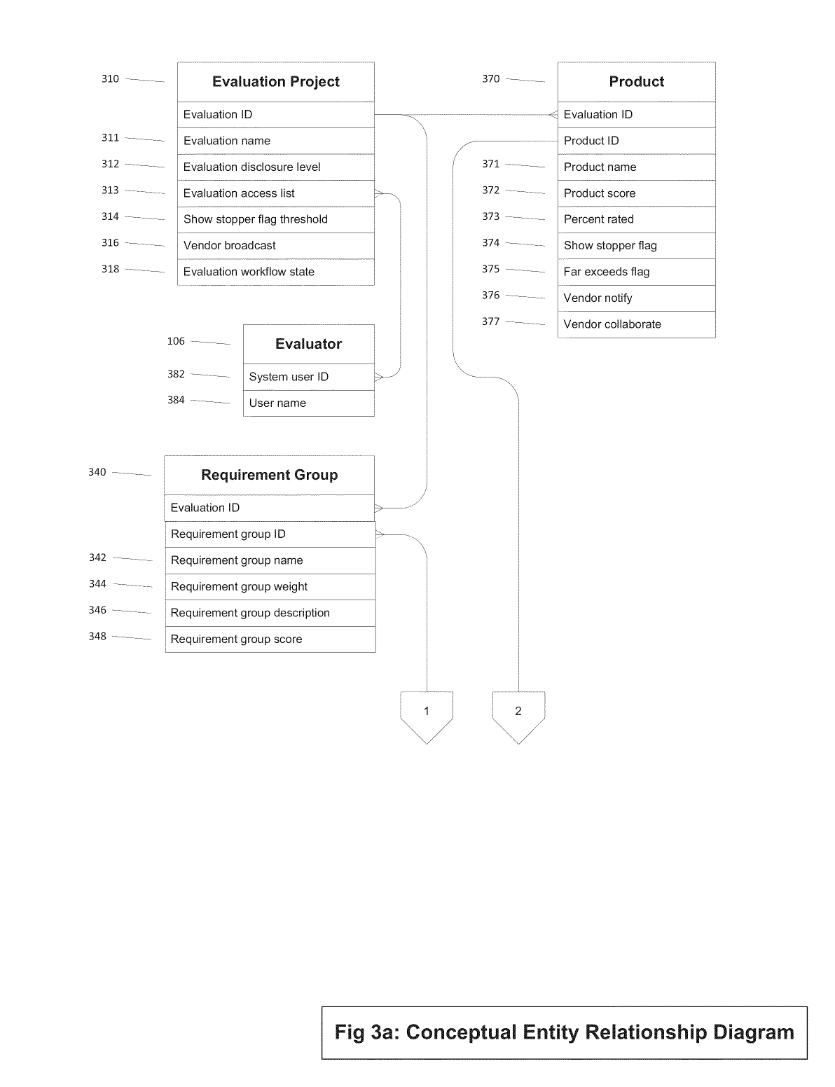

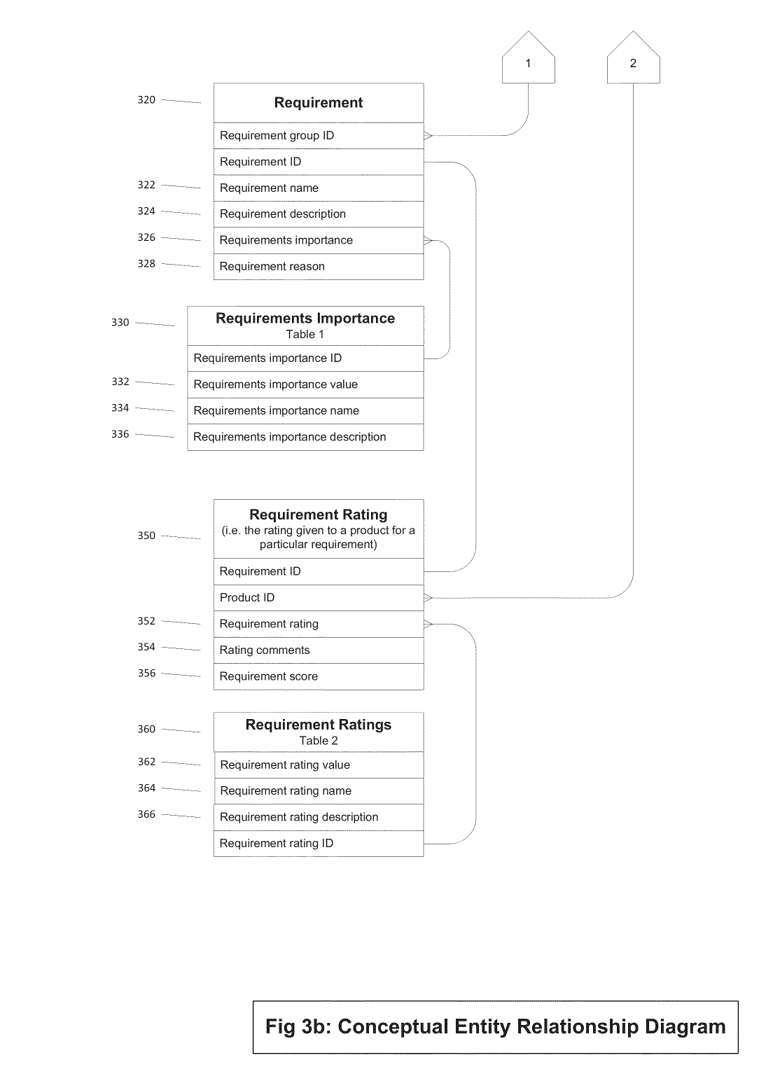

Users in different roles interact with the evaluation system 202 disclosed herein. Examples of user roles are evaluators 106, vendors 108, and advertisers 114. FIG. 2 shows how these roles and also external systems like advertising services 116 relate to the disclosed evaluation system 202. The system 202 comprises the database 104 and web server 102, the software running on the servers and database, as well as all the connections discussed above and in FIG. 1, in addition to other connections. The system 202 provides for an easy and efficient flow of information between the various players and components in the evaluation process.

In FIG. 2 the system 202 is described in terms of the major roles which interact with it. These roles are listed below, along with examples of typical information that the roles exchange with the system 202.

### Evaluators 106

In some embodiments, evaluators 106 provide information to system 202 and receive information from the system 202. Evaluators 106 may also receive payments if their evaluations are sold or their contact details are sold as sales leads.

Typical examples of information flowing from evaluators 106 to the system 202 are:
1. Contact information—the evaluator 106 keeps their contact and user account details up to date.
2. Evaluation projects 310 and requirements 320—the evaluator 106 creates evaluation projects 310 and then adds their purchase requirements 406.
3. Vendor contact requests—the evaluator 106 requests the system 202 connect them with selected vendors 108 of the products 370 they are or might be evaluating.
4. Product ratings—the evaluator 106 rates products 370 against the requirements 320.
5. Comments 414—the evaluator 106 makes comments about how well products 370 being evaluated meet the particular requirements 320. In addition to text, comments can include things like screen shots, photos and attached files.

Typical examples of information flowing from the system 202 to evaluators 106 are:
1. Product recommendations—the system 202 recommends certain products 370 to the evaluator 106 for inclusion in the evaluation project 310. These recommendations can be based on the evaluation requirements 320 or products 370 already being evaluated, and may include paid recommendations from vendors 108.
2. Advertisements—advertising systems 116 present advertisements to evaluators 106 while they are evaluating products 370.
3. Evaluation projects 310—the evaluator 106 buys copies of completed evaluation projects 310 from other evaluators 106 who have similar purchase requirements 320.
4. Product evaluations—the evaluator 106 buys copies of completed product evaluations from other evaluators 106. (Note: An evaluation project 310 contains one or more individual product evaluations. Individual product evaluations can be purchased from an evaluation project 310.)
5. Product rankings—the system 202 ranks products, based on the requirements of the evaluator 106.
6. Payment reports—the system 202 reports to the evaluator 106 any monies earned from reselling their evaluations, or any monies spent in purchasing evaluations.

### Vendors 108

Vendors 108 can also provide information to the system 202 and receive information from the system 202.

Typical examples of information flowing from vendors 108 to the system 202 are:
1. Contact information—evaluators 106 can easily contact vendors 108 while they are working on product evaluations.
2. Product definitions and suggested requirements—the vendor 108 uploads their products to the product catalog 504 in the system 202, along with suggested evaluation requirements.
3. Comments—a vendor 108 comments on an evaluation currently underway, after being invited to do so by an evaluator 106.

Typical examples of information flowing from the system 202 to vendors 108 are:
1. “Vendor Notify” 376 contact notifications—an evaluator 106 uses the system 202 to request that the vendor 108 contact them.
2. “Vendor collaboration” 377 notifications—an evaluator 106 uses the system 202 to request that the product vendor 108 collaborate with them on a product 370 evaluation.
3. “Vendor Broadcast” 316 notifications—the system 202 notifies a vendor 108 that a potential product buyer (i.e. the evaluator 106) is evaluating competing products 370, and the vendor 108 may want to suggest that their products should be included in the evaluation project 310.
4. Product evaluation notifications—the system 202 notifies the vendor 108 that their products are being evaluated.
5. Real time statistical reports 514—the vendor 108 gets real time statistical information on products 370 currently being evaluated. The vendor 108 gets real time information on who is currently evaluating their products, competitive products; current market trends (e.g. are evaluations of a particular product type trending up or down?) etc.
6. Evaluation projects purchases 512—the vendor 108 purchases completed evaluation projects 310 from evaluators 106.
7. Billing reports—the system reports to the vendor 108 how they have been spending money in the system 202, e.g. in purchasing evaluation projects 310.

### Advertising Systems 116

Advertising systems 116 are those that create automated ads, such as banner ads on Websites. An example is Google's AdSense, and there are many others. In some embodiments of the system 202 the advertising system 116 is external. In other embodiments the system 202 may itself serve up advertisements on evaluator pages. In yet other embodiments, there may be a combination of these two approaches.

An example of information flowing from the system 202 to advertising systems 116 is:
1. Advertising code—the system 202 embeds a small code fragment in the Web page requested by an evaluator 106. When the evaluator 106 displays the page on their computer, this code displays an advertisement directly from the advertising system 116. In some embodiments these advertisements may be context sensitive; in other embodiments they are not.

Typical examples of information flowing from advertising systems 116 to the system 202 are:
1. Click through and impression reports—the advertising system 116 reports to the system 202 how effective advertisements have been.
2. Earnings reports—details of the money earned by the system 202 for displaying advertisements.

### Advertisers 114

In some embodiments, besides the evaluators 106 and vendors 108, advertisers 114 also access the system 202. In some cases advertisers 114 act on behalf of vendors 108, in other cases vendors 108 may handle the advertising themselves, or some combination thereof. Depending on the relationship with the vendor 108, the advertisers 114 may also exchange information with the system 202.

Typical examples of information flowing from the system 202 to advertisers 114 are:
1. Click though and impression reports.
2. Real time advertising statistics—the advertiser 114 gets real time information on who is currently evaluating their products, and also competitive products. The advertiser can use this information to dynamically adjust advertising campaigns in real time.

An example of information flowing from advertisers 114 to the system 202 is:
1. Advertising—the system 202 is delivering advertisements to evaluators 106.

### Payment Systems 118

Payment systems 118 can be Web-based payment systems, such as PayPal and similar. These systems 118 make it easy and efficient for the evaluators 106 to sell their evaluations to vendors 108.

Typical examples of information flowing from the system 202 to payment systems 118 are:
1. Payment instructions—instructions to make a payment to an evaluator 106 for an evaluation that has been sold to a vendor 108.

Typical examples of information flowing from payment services 118 to the system 202 are
1. Payment confirmations—confirmation that a payment or refund request has been processed.
2. Payment reports—showing the earnings from evaluations, or how a vendor 108 has spent money on purchasing information from the system 202.

### Sales Team 204

The system 202 collects information from evaluators 106 for resale: qualified sales leads, real time marketing information, and completed evaluations 310. In this embodiment the system 202 provides the (internal to system) sales team 204 with potential customers (i.e. vendors 108 and advertisers 114) who might purchase this information from the system 202.

Examples of the information flowing from the system 202 to the sales team 204 are:
1. Sales leads—the system 202 supplies lists of vendors 108 or advertisers 114 who could be interested in purchasing evaluation related information.
2. Evaluation reports—the sales team 204 gets an overview of evaluation activity in the system, e.g. evaluation counts by date, evaluations by rating, evaluations by product type etc. These give the sales team 204 an overview of the activity and trends in the system 202.

An example of information flowing from the sales team 204 to the system 202 is:
1. Customer sales notes—the sales team 204 records contact of a potential customer in an attempt to interest that customer in purchasing information from the system 202.

### General Operation of the System

### Creating Accounts

In some embodiments, before an evaluator 106 can use the evaluation system 202 disclosed herein the evaluator creates an account on the system 202. In one embodiment there is no charge for setting up an account. The process is similar to setting up a free email account on one of the many commercial services, such as Gmail, Yahoo, and the like. In some embodiments, the account is stored on the system 202 so that the next time the evaluator 106 accesses the system 202 their information will be available. In other embodiments, the evaluator 106 can sign up on the system 202 as a “guest” where the information for only that one-time use is obtained, but no account is generated.

Evaluators 106 and other users are encouraged to enter certain details, such as their geographic location, industry and specialties. This information is utilized if the evaluator 106 wants to be connected to vendors 108. While an evaluator 106 can enter any information, whether valid or not, in one embodiment remuneration earned from selling evaluations rests on the user having entered valid account details. In one embodiment, the evaluator 106 is paid via payment systems 118. In another embodiment, a check is mailed to the evaluator 106. In yet another embodiment, the evaluation system 202 disclosed herein comprises a payment system, similar to PayPal, but exclusively for the evaluators 106 and vendors 108 with accounts in the evaluation system 202.

When a new evaluator 106 account is created, account defaults are initialized from system defaults. These defaults can be edited by the evaluator 106 if required. These values are used as default values for all new evaluation projects 310 created by the user.

In some embodiments, users can create corporate accounts. This allows the corporation to manage access to all their information in the system 202 from one place.

### Account Management

Once an evaluator 106 has created an account and logged in, the evaluator 106 can manage their account. In one embodiment, evaluators 106 can see and manage one or more of the following:
1. Account settings like user name 384, password, email address etc.
2. All default values for their account.
3. All the evaluations they own.
4. The evaluations they have collaborated on, provided they have access to those evaluations.
5. Any copies of evaluations they have bought.
6. Shared folders they have access to, and evaluations made available through those shared folders.
7. Any purchased statistical reports run on the database, e.g. dynamic statistical reports.
8. Any money earned selling evaluations. They can also adjust the threshold at which a payment is made to them.

All the above concepts are explained below in more detail.

### Evaluations

Evaluation projects 310 (or simply evaluations) are the means by which an evaluator 106 compares 418 products 370 against their purchase requirements 320 for the purpose of finding the product 370 best matched to those requirements 320, and then purchasing 420 that product 370. Usually several products 370 are evaluated on an evaluation project 310, but it is also valid to evaluate how well just one product 370 meets the requirements 320 and compare it to the hypothetically perfect product. Typically evaluators 106 create an evaluation project 310, add requirements 406 and products 408, rate those products against the requirements 350, compare 418 the rated products to each other, and then select a product 370 that best matches their requirements 320 for purchase 420.

Each evaluation project 310 has an evaluation owner 106. The evaluation owner may be the company who is intending to purchase a product, or a division within a company, or a household. In some embodiments ownership of an evaluation project 310 is claimed via the person who creates that project. In some embodiments, the evaluation owner and the evaluator 106 are one and the same, whereas in other embodiments, evaluators 106 are employees, associates, or family members of the evaluation owner. While the evaluation owner seeks the input from the evaluators 106, the control of access to the evaluation project, rests with the evaluation owner 106 and any other evaluator 106 who has “Manager” access to the evaluation project 310. See Table 6—Evaluation Access Levels.

### Creating a New Evaluation

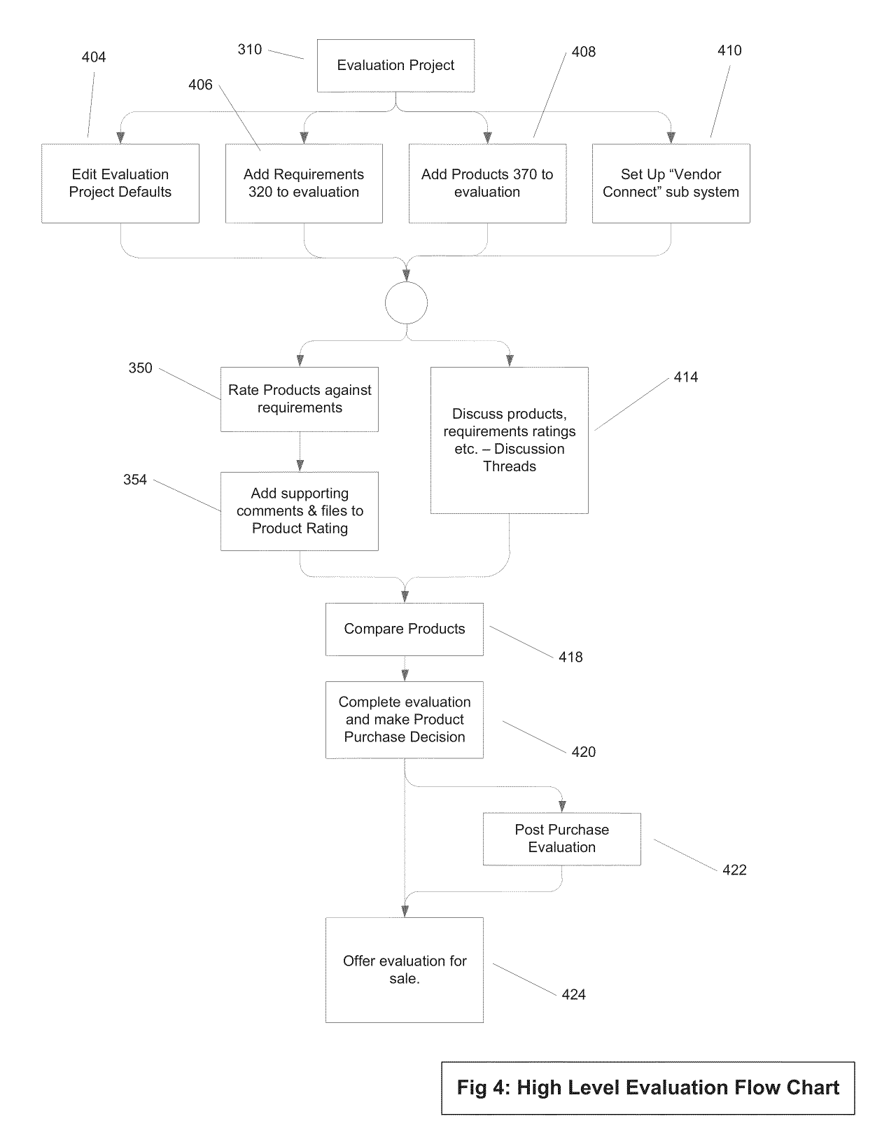

The evaluation work flow is illustrated in FIG. 4. After logging in to the system, the evaluator 106 can either create a new evaluation project 310, or open an already-established evaluation project 310. When a new evaluation project 310 is created, the evaluator gives it a name 311 and the system 202 copies certain default settings from the evaluator's 106 account into the new evaluation project 310. After creating a new evaluation project 310 or opening an existing evaluation project 310, the evaluator 106 can:
Edit the evaluation defaults 404 if necessary
Add other users to the evaluation 310. They are given appropriate access levels:
see Table 6—Evaluation Access Levels
Add or edit purchase requirements
Add new products for evaluation
Set the Show Stopper flag threshold 314
Set up Vendor Connect 410.

Once the evaluation project 310 is created, and the requirements 406 and products 408 are added, the evaluator 106 will use the evaluation system 202 discussed below to rate products 370 against their requirements 350. Evaluators 106 can support their evaluation of a product 370 against a particular requirement 320 by adding comments 354 on how any product 370 meets that particular evaluation requirement 320. These comments can be further supported with screen shots, photos or other attached files, and greatly adding to the value of the evaluation if it is sold.

### Evaluation Collaboration

Any evaluation project 310 has one or more evaluators 106 contributing to the requirements 320. In some embodiments, each evaluator 106 can have a different weighting factor. This weighting factor defaults to 1.0, and can be adjusted up (more influence on the decision) or down (less influence), depending on the relative importance of the evaluator 106 in the evaluation. For example, when evaluating an accounting package, an evaluator 106 from the Finance department could be weighted at 1.5, while an evaluator 106 from the Information Technology department could be weighted at 0.7. Conversely, if a technical software product 370 was being evaluated, the evaluator 106 from the Finance department could be weighted as 0.5, whereas the evaluator 106 from the Information Technology department could be weighted as 2.0

During the evaluation, evaluators 106 with appropriate access levels to the evaluation 310 can collaborate and evaluate different products 370 simultaneously. For example, if an evaluation 310 contains ten potential products 370 that could satisfy the purchase requirements 320, and ten different evaluators 106 evaluate one product 370 each, the product evaluation part of the evaluation project 310 will be completed in about 10% of the time it would take one evaluator 106 working on evaluating ten products 370.

Evaluators 106 can also add comments in the form of a discussion thread 414 to items on an evaluation, (i.e. requirements 320, products 370, importance values 330, or requirement ratings 350 etc.). This information stays with the evaluated product 370 and may provide context to purchasers of the evaluated product 370.

### Requirements

The step of adding requirements 406 is discussed here in more detail. Once the evaluator 106 is satisfied with the default settings 404 for a new evaluation 310, they can move on to defining what needs the proposed purchase should satisfy, generally known as the purchase requirements or simply the requirements 320. Note that since the system 202 is used to evaluate and compare complex products for purchase decisions 418, every evaluation project 310 will have multiple requirements 320.

### Defining Requirements

Properly defined and documented requirements are essential to reduce purchasing risks. The closer the documented requirements 320 are to the “real” requirements, the lower the risk of purchasing the wrong product 370. The evaluation owner 106 creates an initial list of these requirements 320. These requirements are usually enhanced as the evaluation project progresses. This happens when an evaluator 106 evaluates new products—the features of those new products often cause the evaluator to realize that relevant requirements are missing from the evaluation. The evaluator 106 then adds those requirements 320 to the evaluation 310. This approach of using products 370 to identify missing requirements 320 is a powerful technique for finding previously unknown requirements and thus improving the quality of the evaluation.

The purchase requirements 320 can be directly created by the evaluator 106, where each requirement 320 is given a name 322, a description 324 and a reason 328. The requirement name 322 is a short descriptive tag that identifies the requirement 320 in the evaluation project 310. The requirement description 324 fully describes WHAT the requirement is. The requirement reason 328 describes WHY the requirement exists from the evaluator's 106 perspective.

For example, requirement name 322: “Attach notes to item”, requirement description 324: “Has ability to attach notes, files, photos etc. to item”, requirement reason 328: “Preserves background, contextual information about item for later reference. Helps understand why decision was made.” Knowing why the requirements exist is vital to properly evaluating products. It also adds significant value when selling an evaluation 424.

Other ways to add requirements 406 are to import them from existing or purchased evaluations, or from a product in the product catalog 504. The system 202 may also have a library of requirements for common evaluations that evaluators 106 can use.

### Requirements Importance

The requirements importance 326 expresses how important a particular requirement 320 is to the purchase, and has a significant effect on the final product score 372. In one embodiment of the system 202, the requirement importance 326 is expressed by selecting a value from Table 1—Requirements Importance 330. Each entry in the Requirements Importance table 330 has a value 332 which is used to calculate the requirement score 356. It also has a short descriptive name 334, and a longer description 336 to provide context for the name.

TABLE 1
Requirements Importance 330

| Value 332— | |
|---|---|
| Name 334 | Description 336 |
| 6—Show | If this requirement 320 is inadequately satisfied, the |
| stopper | product 370 is automatically excluded. Few requirements |
| | are true “show stoppers”, usually most of these are |
| | “critical”. For any requirement 320 with this importance |
| | rating, the product “Show Stopper” flag 314 counter is |
| | incremented by one if the rating is below the “show |
| | stopper” threshold 314. |
| 5—Critical | This requirement 320 is almost essential, almost a must |
| | have. If it is not satisfied, the product 370 is almost |
| | certainly excluded from purchase. There would be major |
| | limitations using the product 370 without this |
| | requirement 320 being satisfied. |
| 4—Very | If the product 370 does not adequately meet this |
| important | requirement 320, there is a good chance another product |
| | will be selected. There would be significant effort |
| | expended in working around it. |
| 3—Important | Without this requirement 320 being adequately met, |
| | there is some noticeable inconvenience but that can be |
| | worked around with some effort. |
| 2—Useful | A useful requirement 320 if satisfied, but if not there |
| | would only be a minor inconvenience in working around |
| | it. |
| 1—Nice to | This is not really a requirement 320. Nice to have if it |
| have | is satisfied, but nothing to worry about if it is not. |
| 0—No | No need for this requirement, don't care if it is |
| interest | satisfied or not. This rating verifies the requirement |
| | 320 has been considered. For example, used where an |
| | evaluator 106 from one department could set the |
| | requirement importance to “3—Important”, while an |
| | evaluator from another department could set the |
| | requirement importance to “0—No interest” |

Many evaluations 310 in a corporate setting have multiple departments with requirements 320 that must be satisfied. For example if the evaluation project 310 is to decide which Project Management Accounting System a corporation should purchase, the Finance, Information Technology and Project Management Office departments could all have requirements 320 on that evaluation.

In one embodiment each requirement 320 has a requirements importance value 326. Other embodiments allow multiple evaluators 106 (representing different departments) to have different requirements importance values 326 for each requirement. For example, a project accounting requirement could be “4—Very important” to the Finance department, but the same requirement could be “1—Nice to have” to the Information Technology department.

In one embodiment, when a new evaluation project 310 is created the Requirements Importance Table 330 values as described above are copied from the evaluation owner defaults. However requirements importance values can be weighted differently if necessary, for example they could be weighted as 0, 1, 2, 4, 8, 16, 32. The names 334 and the descriptions 336 of the requirements importance 330 can also be edited, e.g. for different languages.

### Requirement Groups

To help manage long lists of requirements 320, related requirements can be collected into requirement groups 340. In this embodiment these requirement groups 340 are one level deep. In other embodiments, requirement groups 340 are nested (i.e. groups can contain other groups), for example, to 3 levels deep. Each requirement group 340 has a descriptive name 342, and fields to record the group weight 344, a description of what the requirement group is used for (i.e. why the requirement group exists and what sort of requirements should be in that group) 346, and the requirement group score 348.

In this embodiment, the requirement group score 340 is calculated by taking the average requirement score 356 from all the requirements in that requirements group 340. Using an average score means that the group score is independent of the number of requirements in that group. Other embodiments may use different methods to calculate group scores 348.

Each requirement group 340 has a default weight 344 of 1, which can be adjusted up (greater influence) or down (lesser influence) by the evaluation owner 106, depending on how important that requirement group 340 is. For example, on an evaluation project 310 the “Security” group of requirements could be weighted at 1.5, whereas the “Collaboration” group of requirements could be weighted at 0.8.

One requirement 320 can appear in multiple requirement groups 340. In some embodiments, each requirement 320 has the same requirements importance 326 under every requirement group 340 that contains it, whereas in other embodiments, the requirements importance 326 differs depending on the particular requirement group 340.

### Products

Once an evaluation project 310 is created, products 370 to be evaluated can be added 408. This can be done before or after the requirements 320 are added 406. In one embodiment, products 370 are added 408 using one or more of the methods listed below.

Direct entry: Product details such as product name 371, vendor, URL, cost etc. are directly entered into the evaluation project 310 by the evaluator 106.

Product catalog look-up: A product catalog 504, for example a catalog stored in the system 202 can be searched. If suitable products 370 are found they can be imported into the evaluation project 310. Typically products 370 in catalogs are created and maintained by the vendors 108, and can also include suggested requirements 320. The evaluator 106 has the option of also importing suggested requirements 320 along with the product 370. If products 370 are imported with the suggested requirements 320, those requirements can be edited by the evaluator 106 to reflect their unique purchase needs.

Recommendations: After having entered the initial requirements 406 and optionally certain products 408, the evaluator 106 can ask the system 202 for product recommendations. Utilizing the information entered by the evaluator the system 202 can then suggest alternative products 370 for evaluation.

If the products 370 are to be evaluated by an evaluator 106 other than the evaluation owner 106, then, in one embodiment, that evaluator 106 is assigned as the owner of that product 370 in the evaluation project 310. The product evaluator 106 can have one of the following evaluation access levels to the evaluation project 310: Evaluator, Editor or Manager. See Table 6: Evaluation Access Levels below.

### Rating Products Against Requirements

Once most requirements 406 and at least one product 408 have been added to the evaluation project 310, the product evaluation process can start. In this embodiment evaluating a product means rating that product 370 against each individual requirement 320 on the evaluation 310.

When an evaluator 106 rates the product 370 against a requirement 320, the evaluator 106 decides how well the product 370 meets that particular requirement 320. The evaluator 106 may determine this from specifications on the product web site or product documentation, from the vendor sales person, from an informal or formal test of the product, or from previous experience with the product. The evaluator 106 records the result in the requirement rating field 352 by selecting a value from Table 2 below. For example, if the requirement 320 is “Product can email status reports” and the evaluator 106 is satisfied that the product 370 fully meets that requirement 320, the evaluator 106 would record a rating 352 of “4—Fully meets” against that requirement 320 by selecting that entry from the requirements ratings 360 table. See Table 2—Requirement Ratings below.

Table 2 below shows that each requirement rating has a numeric value 362, a name 364 and a description 366. Table 2—Requirement ratings default to the list below, but the value, name and description can be changed by the evaluation owner 106.

TABLE 2
Requirement Ratings 360

| Value—Name | Description |
|---|---|
| 0—Does not | Product 370 does not meet the requirement 320 at all, |
| meet | or the feature is completely missing. |
| 1—Slightly | Product 370 meets the requirement 320, but serious |
| meets | deficiencies exist in the implementation that can't |
| | easily be worked around. |
| 2—Partly | Product 370 has some deficiencies in the |
| meets | implementation of the requirement 320, but they can |
| | be worked around with some effort. |
| 3—Mostly | Product 370 meets the requirement 320 to a large |
| meets | extent. Deficiencies can be reasonably easily worked |
| | around with minimal effort. |
| 4—Fully | Product 370 adequately meets the requirement 320. No |
| meets | compromises are required. |
| 5—Exceeds | Product 370 does more than is required 320. There is |
| | room to grow into this requirement 320, and there is |
| | a reasonable possibility the extra functionality will |
| | be used at some point in the future. |
| 6—Far | Product 370 does an order of magnitude more than is |
| exceeds | required, and there is very little possibility of |
| | that functionality ever being used. Typically this |
| | indicates a mismatch between the requirement 320 and |
| | the product 370 being considered. Example: |
| | Requirement 320: family car seating 5, Product 370: |
| | school bus seating 60. Also flags products 370 where |
| | the evaluator 106 would be paying for features that |
| | will probably never be used. |

Some embodiments allow multiple evaluators 106 to have different weights depending on their interest in the evaluation 310. Other embodiments allow multiple evaluators 106 to rate 352 each requirement 320 differently. For example, the Finance department evaluator 106 could rate a product 370 as “2—Partly meets”, while the Information Department evaluator 106 could rate the same product 370 against the same requirement 320 as “5—Exceeds”. In each case this is a valid rating from the perspective of each evaluator 106.

These embodiments may also allow viewing of product scores 372 from the perspectives of different individual evaluators 106. They may also allow alternative or “what if” scenario analyses with different rating value scales. For example, the product scores 372 can be viewed with different weighting factors for various evaluators 106, to see the effect of adjusting the weightings.

### Requirement Scores

The requirement rating 352 for a product 370 is used to calculate the requirement score 356 for that product 370 against that requirement 320. The requirement score 356 expresses numerically how well a product 370 meets just one particular requirement 320. Also factoring into the requirement score 356 is the requirement's importance 326. Some embodiments may also factor different evaluator 106 weights into the requirement score 356.

Note: It is very important to understand the difference between the requirement rating 352 and the requirement score 356. In this embodiment the requirement rating 352 is a value selected from a list (Table 2—Requirement Ratings) that best describes how the evaluator 106 feels the product 370 meets a particular requirement 320. The requirement score 356 is a function of the evaluator's 106 requirement rating 352 of that product 370 and the requirement importance 326 on the evaluation project 310.

For example, suppose a requirement 320 has an importance 326 of “4—Very important” (from Table 1). Now, if the evaluator 106 rated a product 370 against this requirement 320 as “3—Mostly meets” (from Table 2). Using the numerical values from the requirement importance 326 and the evaluator rating 352, the requirement score 356 could be calculated as:

“4—Very important”*“3—Mostly meets”=12.

To each requirement rating 350 the evaluator 106 can add comments 354 explaining the reasons behind their rating, and also add supporting documentation like screen shots, photos, test results files etc.

The evaluator 106 works through the requirements 320 for a product 370 in any order until either the product 370 has been evaluated against all of the requirements 320, or the product 370 falls so far short of the requirements 320 that there is little point in continuing. Note that a product 370 evaluation can still be useful even if there are some requirements 320 that are unrated.

Often during a product 370 evaluation new requirements 320 come to light and the evaluator 106 can then add those new requirements 406 to the evaluation project 310. Previously evaluated products 370 can then be rated against these new requirements 320. This is a powerful technique for identifying previously unknown requirements. In some embodiments once the product evaluation is complete, the evaluator 106 can add a concluding summary to that product 370.

### Product Scores

An evaluation project 310 consists of products 370 that have been rated 352 against purchase requirements 320. In this embodiment the individual requirement scores 356 are averaged into requirement group scores 348. Then all the requirement group scores 348 are summed to arrive at the final product score 372.

The product score 372 is a single number that measures how well a product 370 meets the particular requirements 320 on an evaluation project 310. The aim of an evaluation project 310 is to evaluate each product 370 against the requirements 320, and generate a product score 372 for each product 370. The products 370 on the evaluation project 310 are then ranked by the product score 372, and the best ranking product 370 is the one usually selected for purchase. In some embodiments this score is expressed as a percentage, where the score of the hypothetically perfect product is used as the 100% point of reference.

The percent rated field 373 tells the evaluator 106 the percentage of requirements 320 for that product 370 that have been rated. Ideally all products 370 on the evaluation 310 should be rated against all of the requirements. The Show Stopper flag 374 counts the number of show stopper requirements that were rated below the show stopper threshold 314. The far exceeds flag 375 counts the number of requirements thus rated, and highlights a mismatch between a product 370 and a requirement 320. It flags products 370 where the evaluator 106 would be paying for features that will probably never be used.

Although the product score is the most important part of making a purchase selection, there are other factors that influence the purchase decision. These are listed in Table 3—Product Score Factors below.

TABLE 3
Product Score Factors

| | |
|---|---|
| Product | A number that expresses how well a product 370 meets |
| score 372 | the requirements 320. In some embodiments this is |
| | expressed as a percentage, where the hypothetically |
| | perfect product is used as a 100% reference point. |
| Percent | The percentage of requirements 320 that have been |
| rated 373 | rated 352 for a product 370. As the percent rated |
| | 373 increases towards 100%, so the accuracy of the |
| | product evaluation improves. |
| Show stopper | A flag indicating the presence of any show stopper |
| flag 374 | requirements 320 that are below the threshold. In |
| | this embodiment the show stopper flag 314 threshold |
| | can be set at the evaluation level to be: Party |
| | Meets, Mostly Meets or Fully Meets. Example: If the |
| | show stopper flag is set to “3—Mostly Meets” and a |
| | show stopper requirement is evaluated to “2—Partly |
| | Meets”, it would trigger the flag for that product |
| | 370. |
| Far exceeds | A flag indicating the count of any “Far exceeds” |
| flag 375 | ratings on that product 370 evaluation. |

### Completing an Evaluation & Product Purchase

In one embodiment, the evaluation project 310 is completed 420 when the evaluator 106 moves the evaluation project 310 into a completed state in the workflow 318. If a product 370 was purchased based on the evaluation 310, the evaluator 106 can include information like the date the purchase was made, the price paid, and a concluding summary explaining why that particular product 370 was selected. If no purchase was made, the evaluator 106 can explain why that happened.

If more than one product on an evaluation 310 was evaluated, then the evaluation owner 106 can compare 418 the various products 370 and make a purchase decision 420. The comparison 418 may simply be comparing the final product scores 372 for each product. Alternatively, the evaluator 106 may evaluate the product scores 372 in the light of the comments 414 entered into the system.

### Post Purchase Evaluations

After the purchase 420, the evaluator 106 may re-evaluate the product 370 in the light of their actual experience with the purchased product 370.

Part of the idea of making evaluations available for sale is for the evaluator to earn money (see Buying & Selling Evaluations below). The evaluator 106 can significantly increase the value of a product evaluation 370 by completing a post purchase evaluation. After using the product for several months the evaluator 106 then re-evaluates the purchased product 370 in the light of their actual experience. Any potential purchaser of the same product 370 finds the post purchasing evaluation extremely valuable because of the depth of insight it offers from somebody who has evaluated and then used the product 370 in real world application. Thus, a post purchase evaluation of a product 370 significantly boosts the earning potential of that evaluation for the evaluator 106.

### Buying & Selling Evaluations

Until now, there was no easy and economical way to evaluate products 370 against user requirements 320. Likewise, until now these product evaluation projects 310 would usually be discarded after the product was bought 420. By providing the means to easily evaluate products and a means to sell those evaluations 424 the system 202 disclosed herein creates a market for those product evaluations 370.

In one embodiment, if the evaluation 310 has the appropriate Evaluation Disclosure Level 312 (see “Table 5—Evaluation Disclosure Levels” below), the act of updating the evaluation workflow state 318 to “complete” makes the evaluation 310 available for sale 424. In another embodiment, the evaluation owner 106 explicitly makes the evaluation 310 available for sale 424. When an evaluation 310 is sold, the evaluation 310 is copied into the purchaser's account on the system 202. In one embodiment, if the evaluator later decides to make an evaluation 310 private, it is no longer available for sale, but anybody who has already purchased that evaluation 310 keeps their copy. In another embodiment, if the evaluation 310 becomes private, the purchaser must return their copy and obtain a refund. The purchase agreement between the evaluator 106 and purchaser of the evaluation will determine the contractual obligations of each party.

### Selling Evaluations

Any completed evaluation project 310 and the products 370 therein can potentially be sold 424 using the system 202 disclosed herein. Usually an evaluation project 310 contains several different, competing products 370. It is usually these individual product evaluations 370 that are sold 424, rather than the entire evaluation 310. However in some embodiments there may be a discount for purchasing all the individual product evaluations 370 on one evaluation project 310. Purchasing the full evaluation allows the purchaser to see how that evaluator 106 rated the products 370 against each other.

The amount of information disclosed in an evaluation 310 is fully under the control of the evaluation owner 106, and depends on the Evaluation Disclosure Level 312 setting (see “Table 5—Evaluation Disclosure Levels” below). In general the more information the evaluation owner 106 is prepared to disclose, the more they can earn from selling an evaluation 370.

In one embodiment, the price of a product evaluation 370 is computed using the factors listed below in Table 4—Evaluation Pricing Factors. Other embodiments may use similar or different factors.

Note that one product evaluation 370 may be sold 512 multiple times to different parties over a long period. The money earned from selling the product evaluations 370 is deposited in the evaluator's 106 account on the system after the purchaser has paid for them. The evaluation owner 106 can then be paid by the payment system 118.

TABLE 4
Evaluation Pricing Factors

| | |
|---|---|
| 1. | The price of the product 370 being evaluated. |
| 2. | The Evaluation Disclosure Level 312 - see Evaluation Disclosure |
| | Level below. In general the more information the evaluator 106 |
| | provides, the higher the price of the evaluation. |
| 3. | The number of requirements 320 on the evaluation, and the number |
| | of requirements the product 370 was rated 352 against. The |
| | amount of information attached to each requirement 320 (which |
| | justifies what is required, and why it is required), and the |
| | comments on each requirement 320. |
| 4. | Whether or not any product 370 was purchased as a result of the |
| | evaluation. If the evaluation project 310 resulted in a product |
| | 370 purchase, then the price is significantly higher. |
| 5. | The age of the evaluation project 310. In general newer |
| | evaluations completed in the last few months are worth more |
| | that evaluations completed several years ago. |
| 6. | Evaluations that contain a post purchase evaluation are |
| | considerably more valuable than ones that do not contain a post |
| | purchase evaluation. |
| 7. | In some embodiments, the time spent evaluating the product. |

### Purchasing Product Evaluations

In general, two groups of system 202 users (i.e. vendor marketing departments 108 or people 106 doing similar types of evaluations) may search for 510 and purchase 512 product evaluations, but other groups such as market research companies may also purchase evaluations.

Evaluators 106: Often an evaluator 106 has a few possible product 370 candidates in mind before starting an evaluation project 310, and may choose to buy a few existing product evaluations 370 as part of their preliminary research. They can use the requirements 320 from these product evaluations 370 as a basis for their own requirements 320, which can save significant time. This can also uncover requirements 320 which might have gone unnoticed. In general, evaluators 106 will tend to buy a relatively small number of evaluations, but there tend to be relatively large numbers of these small purchases.

Vendors 108: Vendors 108 purchase evaluations 512 for market research purposes. They buy evaluations of their own products 370, and of competing products 370. Analyzing these product evaluations 370 provides a relatively fast and highly detailed way to gauge how the market perceives their products and competing products 370.

Note that in some embodiments, if a user has purchased an evaluation, they have a copy of that evaluation in their account on the system 202. If the original evaluator 106 then completes a post purchase evaluation 422, the purchaser is notified by a flag on the purchased evaluation. For a small fee, the purchaser can then upgrade their evaluation to include the post purchase evaluation. In other embodiments, the original purchase price includes the right to obtain the post purchase evaluation as well.

### Sharing Purchased Product Evaluations

In some embodiments, users (typically vendors 108) create corporate account 502. The person who initially creates the corporate account 502 is automatically added to that corporate account, and they can then add or remove other users. A primary benefit of a corporate account is the ability to share information via mechanisms like shared folders 516.

In some embodiments, when a vendor 108 purchases an evaluation 512, it is copied to their account and only they can see it. Other embodiments allow purchased evaluations to be shared using shared folders 516. Comments can be added to purchased evaluations. For example, a vendor 106 marketing department that purchased a product evaluation may want to discuss how the product 370 was evaluated.

Sharing by Copying: A purchased product evaluation 370 can be copied to other users for a fee. If an evaluation is shared in this way, each user gets their own copy, the same as if they had purchased it themselves. Under this scenario if any one user adds a comment to a shared product evaluation 370, that comment can't be seen by any other users.

Sharing with Shared Folders: A purchased evaluation can be shared via a shared folder 516 on the system 202 for a fee. In some embodiments the cost of sharing evaluations this way depends on the number of users who can access the shared folder.

Product evaluations are placed into shared folders 516, and seen by all members of that folder. Typically this is used by vendor 108 marketing departments or product evaluation teams. Users can then make their own comments on these evaluations by means of discussion threads 414, and also see comments made by each other.

### Purchasing Real Time Statistics

As the number of people using the disclosed system 202 to evaluate products 370 increases, the disclosed system 202 become a means to dynamically gauge market interest in particular products 370. For example a laptop vendor 108 can track the rate at which their new products 370 are added 408 to open evaluations 310 to gauge the effectiveness of a marketing campaign in real time. The system 202 can generate real time statistical reports which vendors can purchase 514. These reports can include information like evaluation rates, geographic location etc. Note that:
1. A real time statistical report 514 is run on open evaluations 310, and this is considerably further “upstream” in the sales cycle than quotes, proposals or actual product sales. This allows a vendor 108 to get an earlier look at how their product 370 is performing in the market. For example, if their product 370 is being evaluated at a modest rate, and a competitor's product 370 is being evaluated at a much higher rate, the vendor 108 may want to adjust their marketing campaign.
2. No user identifiable information is included in these statistical reports; they simply notify the vendor 108 of things like how many of their products 370 have been evaluated per time period per location.
3. A vendor 108 can also purchase evaluation statistics for competitor's products 370, and compare this with their own product 370 statistics.

In one embodiment, a vendor 108 can purchase these real time evaluation statistics reports 514. Typically these reports 514 are run on a regular basis, and can be accessed from the vendor's 108 account via shared folders 516. In some embodiments evaluation owners 106 have a small amount credited to their account every time their evaluation is returned in these reports.

### Vendors

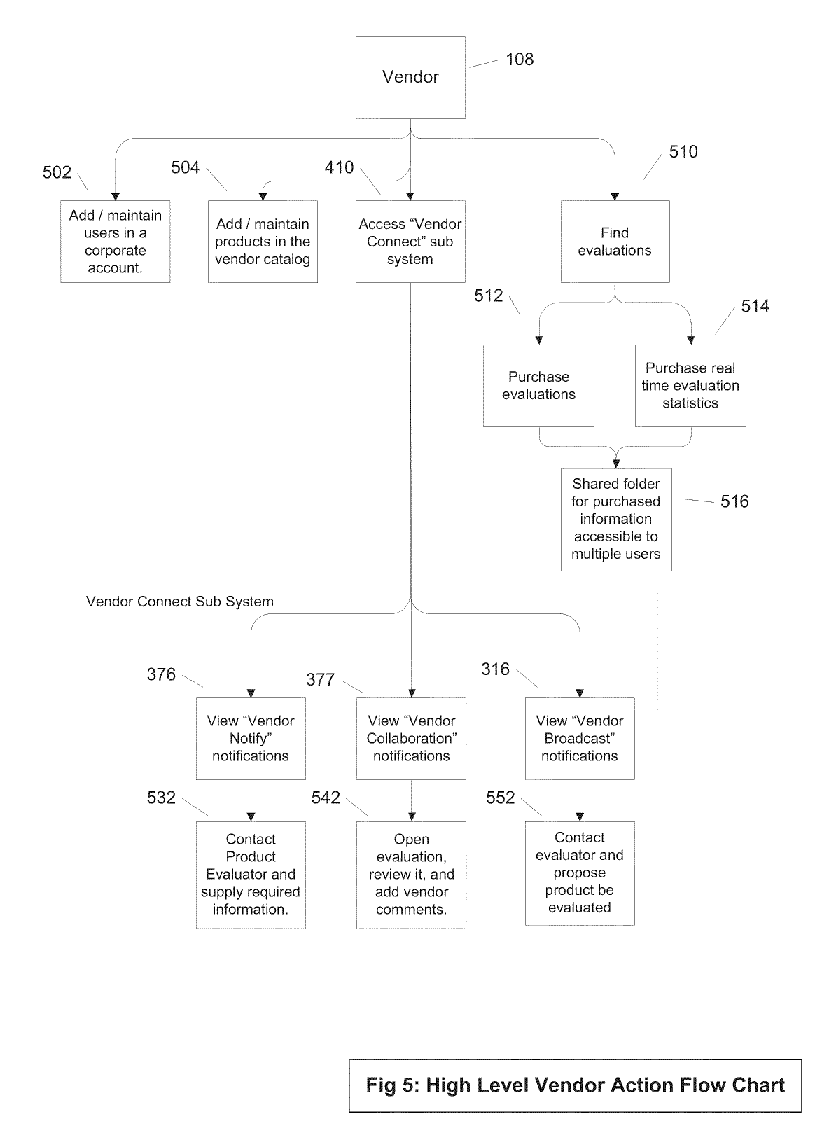

Vendors 108 interact with the disclosed system 202 in several ways as shown in FIG. 5. In general, vendors 108:
1. Add or maintain users in their corporate accounts 502.
2. Add to, and maintain their products in the system's 202 product catalog 504.
3. Use the system 202 to interact with potential product buyers who are evaluating products 370.
4. Purchase evaluations 512 and evaluation statistics 514 for market research purposes.

### The Product Catalog

In one embodiment, vendors 108 create and maintain products 370 in a product catalog 504 on the system 202 that evaluators 106 then add to their evaluation projects 310. Instead of entering all the product 370 information manually, the evaluator 106 searches for products 370 of interest and, if found, imports the product into their evaluation project 310.

When a vendor 108 creates a product in the product catalog 504 they have the option of including suggested evaluation requirements 320. In this way a vendor 108 can encourage evaluators 106 to focus on their product's strong points.

Conceptually a product 370 in the product catalog 504 is very similar to an evaluated product 370 in that it contains both the product description and (optionally) requirements 320. However, unlike a product evaluation, a product 370 in the product catalog 504 does not have evaluation results associated with it.

By adding several products 408 from different vendors 108, the evaluator 106 can very quickly create an initial list of requirements which can then be edited to match their requirements. Another benefit for evaluators 106 is that the vendor created requirements sometimes include requirements 320 the evaluator 106 may have overlooked.

Connecting with Evaluators

In one embodiment, a significant function of the system 202 is connecting vendors 108 to evaluators 106 while an evaluation project 310 is underway (i.e. the evaluation projects 310 are not yet complete). This sub system is called “Vendor Connect” and is fully under control of the evaluation owner 106. There are three parts to the Vendor Connect sub system, which are described below. Usually the evaluator 106 sets up Vendor Connect 410 near the start of the evaluation project 310.

### Vendor Notify

Evaluators 106 can use the system 202 to notify vendors 108 that their products 370 are being evaluated. If Vendor Notify 376 is selected on the product 370 by the evaluator 106, the system 202 emails the vendor 108 informing them that one (or more) of their products 370 are being evaluated, along with relevant details like the product name, the geographic location of the evaluator 106, optionally the requirements 320, etc. The vendor 108 sales can then contact the evaluator 106.

The main purpose of Vendor Notify 376 is to save the evaluator 106 the effort of contacting the vendor 108 to request further product 370 information. Essentially the evaluator 106 is saying “I am interested in your product—who is my sales contact?” Vendor Notify 376 specifically lets only the product vendor 108 know their product 370 is being evaluated. None of the vendor's 108 competitors are informed of the evaluation project 310.

Vendor Notify 376 requires the evaluator 106 to have selected a product 370 from the product catalog 504, or to have entered sufficient vendor 108 details so the system 202 can contact the vendor 108. Vendor Notify 376 is set on the product 370.

In some embodiments the vendor notifications are sent when the Vendor Notify 376 is set on the product 370. Other embodiments may collect multiple vendor notifications from different evaluators 106, and send the vendor 108 just one email at regular intervals. The vendor 108 may also log into the system 202 and view Vendor Notify 376 notifications from multiple evaluators 106, and then contact those evaluators 106 and supply the information requested. After receiving the notification, the vendor 108 contacts 532 the evaluator 106.

### Vendor Collaboration

Vendor Notify 376 simply informs a vendor 108 that their product 370 is being evaluated, and requests the vendor 108 to contact the evaluator 106. In contrast, Vendor Collaboration 377 invites the vendor 108 to participate in the product evaluation 370.

The main purpose of Vendor Collaboration 377 is to ensure the product 370 is accurately and fairly evaluated. If the evaluator 106 has made any errors, the vendor 108 will certainly point them out. Vendor Collaboration 377 is set on the product 370.

In some embodiments vendors 108 are invited to collaborate by email. Vendors 108 may also log into the system 202 and view their vendor collaboration invitations 377. After being invited to collaborate, the vendor 108 uses the system 202 to open the evaluation, review it and add comments 542 etc. The vendor 108 can see the detailed product requirements 320, and how their product 370 has been rated against those requirements 320 by the evaluator 106. For example if a product 370 is rated as “0—Does not meet” the vendor 108 can point out that the product 370 actually does meet that requirement 320, and describe how it does so. The evaluator 320 can then correct the product rating 352 if desired, for example changing it to “2—Partly meets”.

If Vendor Collaboration 377 is enabled for a product 370, the system 202 automatically gives the vendor 108 “Vendor collaborator” access level (See Table 6—Evaluation Access Levels below) to that evaluation project 310. In some embodiments that vendor 108 can then partake in any discussion attached to any requirement 320, importance value or requirement score 356 on their product 370. However in most embodiments vendors 108 can't edit anything on the evaluation like requirements 320, change the requirement rating 352 for their product etc. In some embodiments a collaborating vendor 108 can only see their product(s) 370, and not competitive products 370. Other embodiments may handle evaluation project 310 security differently.

### Vendor Broadcast

Both Vendor Notify 376 and Vendor Collaboration 377 are communications from the evaluator 106 to a specific vendor 108, namely the particular product vendor 108. In contrast, Vendor Broadcast 316 informs multiple vendors 108 of an evaluation project 310 that may be of interest to them. The main purposes of Vendor Broadcast 316 are:
1. To help evaluators 106 to locate products 370 that they had not previously considered, but potentially could satisfy their requirements 320 better than the products 370 they are currently considering. Vendor Broadcast can save the evaluator 106 a significant product research effort.
2. To provide an opportunity for evaluators 106 to earn remuneration by selling sales leads to vendors 108.
3. To allow vendors 108 to purchase subscriptions to highly qualified sales leads that are very close to the purchase decision.

When enabled on an evaluation project 310, vendors 108 who have purchased a Vendor Broadcast 316 subscription are notified that there is an open evaluation project 310 containing product categories where they could potentially make a sale. The Vendor Broadcast 316 selects potential vendors 108 based on the requirements 320 in the evaluation, and any products 370 already on the evaluation project 310. In some embodiments the Vendor Broadcast 316 information is delivered to the vendor 108 by email, and can also be viewed directly on the system 202.

The Vendor Broadcast 316 notification includes detailed evaluation requirements so the vendor 108 can decide if their product 370 really does match the evaluator's 106 requirements 320 and information like the geographical location and industry of the evaluator 106 so the appropriate vendor 108 sales can make the contact. Vendor sales 108 can then contact 552 the evaluation owner 106 to suggest their product 370 be included in the evaluation project 310.

Vendor Broadcast 316 is set on the evaluation project 310. By enabling Vendor Broadcast 316, the evaluation owner 106 is allowing vendors 108 to purchase access to an active evaluation 310 for the purpose of vying for the business. Revenue earned in selling these active prospect sales leads to vendors 108 is shared with the evaluation owners 106.

### Advertising

In one embodiment, advertisements are displayed while the evaluator 106 is performing the evaluation. Using the requirements 320 entered into the system 202 and any products 370 the evaluator 106 has already added 408 to the evaluation project 310, the system 202 provides for the display of advertisements for similar products that may interest the evaluator 106. In some embodiments these advertisements may come from systems like the Google AdSense program or similar, or from an internal advertising subsystem on the system 202, or both. In some embodiments the price charged for advertising may depend on how complete the evaluation is or how much work has been done on the evaluation.

### Security

### Evaluation Disclosure Levels

The Evaluation Disclosure Level 312 controls how much information is made available to purchasers when an evaluation is sold 424. It is fully under the evaluation owner's 106 control. In one embodiment, the evaluation owner 106 can set the Evaluation Disclosure Level 312 as defined by Table 5 below, which lists how much information is disclosed to evaluation purchasers.

Note that in this embodiment only completed evaluation projects 310 are offered for sale. Allowing access to the evaluation project 310 before it is complete allows vendors 108 access, e.g. for collaboration or statistical summaries, but the system 202 does not offer incomplete evaluations for sale.

TABLE 5
Evaluation Disclosure Levels

| Eval Disc | |
|---|---|
| Level 312 | Description |
| Private | Keep an evaluation completely private, only visible to |
| | those people who are explicitly granted access in the |
| | evaluation access list. The evaluator 106 cannot earn |
| | any remuneration from a private evaluation. |
| Statistical | Allow statistical access to the evaluation. No |
| | evaluator 106 details are disclosed, but evaluation |
| | products 370 are used in real time statistical |
| | reports 514 (e.g. a count of the number of times a |
| | particular product 370 is listed in currently open |
| | evaluations). No drill down to product evaluations |
| | 310 is permitted from statistical reports. This type |
| | of evaluation earns the lowest level of remuneration. |
| Anonymous | Make an evaluation available anonymously. Somebody |
| | else can purchase products 370 on the evaluation 310, |
| | but they cannot see any names attached to the |
| | evaluation. In some embodiments the purchasers |
| | can't see any discussion thread on any |
| | requirement, importance value or evaluation score. |
| Named | Evaluator(s) identified. Somebody can purchase the |
| | evaluation, and they can see names attached to the |
| | evaluation. They can also see all discussions attached |
| | to any requirement importance 326 or product |
| | evaluation score 372. The evaluator 106 has the option |
| | of setting a flag on the evaluation that allows other |
| | users to contact them if desired. |
| Fully | Evaluator(s) 106 are identified, as is the company |
| identified | performing the evaluation. A means of contacting the |
| | evaluation owner 106 via the system 202 is provided. |
| | This type of evaluation earns the highest level of |
| | remuneration. |

### Evaluation Access Levels

In this embodiment Table 6—Evaluation Access Levels lists possible access levels for people who are explicitly named (either directly or via group membership) in an evaluation's access list 313. Other embodiments may have different access levels.

TABLE 6
Evaluation Access Levels

| | |
|---|---|
| Minimum | The default access level on an evaluation 310. The user |
| | can see the project 310 and the requirements 320, but |
| | no products 370. When a user is added to an evaluation |
| | they get minimum access by default. |
| Readers | People with read only access to an evaluation 310 can |
| | view all products 370 on the evaluation 310, but cannot |
| | make any changes or add any comments. Typically used |
| | for executives etc. |
| Collaborator | Reader access, with the ability to add comments. Can |
| | see but not change or add to the products 370, |
| | requirements 320, ratings 352 etc. in an evaluation |
| | 310. Can add discussion threads 414 to those items. |
| Vendor | Similar to collaborator, but limited access. Access is |
| Collaborator | authorized by product 370, and normally restricted to |
| | that vendor's product(s) 370. Allows a vendor 108 to |
| | take part in an evaluation of their product 370, and |
| | only see their product 370. A Vendor Collaborator can |
| | add comments to the evaluation 414. |
| Evaluator | Allows a person to evaluate products. If the |
| | “Evaluators edit requirements” flag on the evaluation |
| | project 310 is set, they can also edit requirements. |
| Manager | Same access as an evaluator 106, but can also manage |
| | the users on an evaluation 310 and control the type of |
| | access each user 106 has to the evaluation 310. The |
| | person 106 who creates an evaluation 310 is a manager |
| | by default, and an evaluation 310 can have multiple |
| | managers. Manager can also add products to an |
| | evaluation 408. |
| Owner | Every evaluation 310 MUST have an owner 106, who is |
| | by default the person who creates the evaluation 310. |
| | There can only be one owner for an evaluation 310, |
| | and that person gets paid if any product 370 on the |
| | evaluation is sold. The evaluation owner has manager |
| | access, and can be changed if required. |

### Revenue Streams

In one embodiment, the system 202 supports a business model with multiple revenue streams. These are listed below, and all assume the evaluation system 202 has established itself as a service in the market place. The information may be sold in batches, or alternatively may be sold on a subscription basis.

Product Evaluation Sales to vendors: It is anticipated that vendors 108 will purchase relatively large quantities of product evaluations continuously, and this will become a standard part of their market research.

Product Evaluation Sales to evaluators: It is anticipated that large numbers of evaluators 106 will purchase relatively small quantities of evaluations 310 to help them as part of the due diligence process when evaluating products 370.

Advertising Sales: The closer to the actual purchase, the more valuable advertising real estate is to advertisers. It is anticipated vendors 108 or advertisers 114 acting on their behalf will pay a premium to advertise on the service because it is so close to the sale.

Real Time Statistical Reports 514: It is anticipated vendors 108 will purchase real time statistical reports 514 to identify market trends as they are happening. Also, instead of conducting user surveys, vendors 108 can dynamically query historical data in the evaluation database and analyze the results.

Vendor Broadcast 316: It is anticipated that vendors will purchase Vendor Broadcast subscriptions as a means of generating premium sales leads.

Product Recommendations: When requested by the evaluator 106, the system 202 will offer product recommendations based on the user's requirements 320, and the products 370 already on an evaluation 310. In one embodiment, the first two product recommendations will be paid listings, and clearly marked. Vendors 108 may purchase these first two product recommendations.

Enhanced Catalog Listings: It is anticipated that some vendors 108 will purchase enhanced product catalog 504 listings to show their products 370 in a better light.

### CONCLUSION

The systems 202 disclosed herein above comprises blocks, sections functions and modules. However a skilled technologist will realize there are many ways to partition and arrange the systems, and there are many parts, components, modules or functions that may be substituted for those above.

As should be appreciated by a skilled technologist the processes performed by the above described software may be rearranged to other modules, described by different flowcharts, and combined in many different ways. The software may be written in any programming language, and executed under any current or future compatible operating system.

What is claimed is:

1. A method of selecting a product for purchase, the method comprising:
creating an evaluation project on a computer system;
providing a set of at least two purchase requirements for the product;
selecting at least two candidate products from among which the product to be purchased is selected;
evaluating each candidate product against the purchase requirements and assigning a score for each candidate product for each purchase requirement;
using a processor, generating a cumulative product score based on the assigned scores for each purchase requirement; and
selecting a product for purchase based on the cumulative product score.

2. The method of claim 1, wherein each evaluation requirement is related to a feature or function of the product.

3. The method of claim 1, wherein the score for each requirement is weighted based on the importance of the requirement in the overall evaluation.

4. The method of claim 1, wherein the set of requirements are stored on the computer system.

5. The method of claim 1, wherein the at least two purchase requirements is provided by the same individual who evaluates each candidate product.

6. The method of claim 1, wherein the at least two purchase requirements is provided by a different individual than the one evaluates each candidate product.

7. The method of claim 1, wherein the evaluating step is performed by a plurality of evaluators.

8. The method of claim 7, wherein the cumulative product score is a function of the cumulative score of each one of the plurality of evaluators.

9. The method of claim 8, wherein the cumulative score for at least one of the plurality of evaluators is weighted differently than the cumulative score of at least one other of the plurality of evaluators in calculating the cumulative product score.

10. The method of claim 1, wherein an individual other than an evaluator has real-time access to the evaluation project during the evaluating step or after a cumulative product score is generated.

11. The method of claim 10, wherein the individual other than an evaluator is a product vendor or an advertiser.

12. The method of claim 10, wherein the real-time access is a paid access.

13. The method of claim 12, wherein the cost of access depends on the completeness of the evaluation.

14. The method of claim 1, further comprising selling or trading a completed evaluation project prior to selecting a product for purchase.

15. A method of tracking market interest in a product in-real time, the method comprising:
creating an evaluation project on a computer system;
providing a set of at least two purchase requirements for the product;
selecting at least two candidate products from among which the product to be purchased is selected;
collecting scores for each purchase requirement for each candidate product, wherein the scores are obtain by evaluating each candidate product against the purchase requirements and assigning a score for each purchase requirement for each candidate product;
using a processor, generating a cumulative product score based on the assigned scores for each purchase requirement; and
determining market interest in the product based on the cumulative product score.

16. A system for evaluating products, the system comprising:
a first processor comprising a database, wherein the database is configured to contain i) purchase requirements for at least one candidate product to be evaluated, and ii) a score for each purchase requirement for each candidate product; and
at least one workstation for an evaluator to access the database.

17. The system of claim 16, wherein the first processor is in communication with a second processor selected from the group consisting of a processor of an evaluator of the product, a processor of a vendor of the product, a processor of an advertiser; and a processor of a payment system.

18. The system of claim 17, wherein the first and second processors communicate through the internet.

19. The system of claim 17, further comprising a firewall between the first processor and the second processor.
